(19) United States
(12) Patent Application Publication
(10) Pub. No.: US 2009/0217870 A1
(43) Pub. Date: Sep. 3, 2009

(54) Sheet Product and Flowable Product Dispenser System

(75) Inventor: Phuong Van Luu, Appleton, WI (US)

Correspondence Address: Georgia-Pacific LLC, Patent Group GA030--41, ATLANTA, GA, 30303, US

(73) Assignee: Georgia-Pacific Consumer Products LP, Atlanta, GA (US)

(21) Appl. No.: 12/041,243

(22) Filed: Mar. 3, 2008

(51) Int. Cl. B05C 3/12

(52) U.S. Cl. 118/419

(57) ABSTRACT

A sheet product dispenser system comprising, a sheet product dispenser portion operative to dispense a sheet product, a first roller operative to transfer a flowable product from the first roller to the sheet product and a first flowable product dispenser having a cavity partially defined by the first flowable product container, operative to store the first flowable product, and a first flowable product applicator engaging the first flowable product container and operative to apply the first flowable product to the first roller, the first flowable product applicator including, an opening partially defined by the first flowable product applicator communicative in fluid communication with the cavity and the outer surface, and a ball member engaging the opening operative to control dispensing of the first flowable product on the first roller, and a controller operative to receive signals and control the sheet product dispenser system.

### BACKGROUND OF THE INVENTION

The present disclosure relates generally to sheet product dispenser systems, and particularly to sheet product dispenser systems that apply flowable products to sheet products.

Users who utilize sheet product dispensers to dry and wash their hands often use a flowable product such as soaps, antibacterial agents, grease-cutting agents, cleaning solutions and lotions.

Some sheet product dispensers dispense sheet products that are impregnated with a flowable product. Often these dispensers use a roll of sheet product that has the flowable product impregnated in the sheet product prior to installing the sheet product in the dispenser. It is desirable to have a sheet product dispenser that applies flowable products to a sheet product.

### BRIEF DESCRIPTION OF THE INVENTION

An exemplary embodiment including a sheet product dispenser system comprising, a sheet product dispenser portion operative to dispense a sheet product, a first roller operative to transfer a flowable product from the first roller to the sheet product and a first flowable product dispenser having a cavity partially defined by the first flowable product container, operative to store the first flowable product, and a first flowable product applicator engaging the first flowable product container and operative to apply the first flowable product to the first roller, the first flowable product applicator including, an opening partially defined by the first flowable product applicator communicative in fluid communication with the cavity and the outer surface, and a ball member engaging the opening operative to control dispensing of the first flowable product on the first roller, and a controller operative to receive signals and control the sheet product dispenser system.

An alternate exemplary embodiment including a sheet product dispenser system comprising, a sheet product dispenser portion, a first roller operative to apply a flowable product to a sheet product, a first flowable product dispenser operative to dispose a first flowable product on the first roller, and a second flowable product dispenser operative to dispose a second flowable product on the first roller.

Another alternate exemplary embodiment including a sheet product dispenser system comprising, a sheet product dispenser portion, a first roller operative to apply a flowable product to a sheet product, a first flowable product dispenser operative to dispose a first flowable product on the first roller, a second flowable product dispenser operative to dispose a second flowable product on the first roller, and a controller operative to receive signals and control the sheet product dispenser system.

These and other advantages and features will be more readily understood from the following detailed description of preferred embodiments of the invention that is provided in connection with the accompanying drawings.

### BRIEF DESCRIPTION OF THE DRAWINGS

Referring to the exemplary drawings wherein like elements are numbered alike in the accompanying Figures:

FIG. 1 is a perspective partially cut-away view of an exemplary embodiment of a hand cleansing system.

FIGS. 2 and 3 are perspective partially cut-away views of an alternate embodiment of the hand cleansing system of FIG. 1.

FIG. 4 is a perspective partially cut-away view of an alternate embodiment of flowable product dispensers.

FIG. 5 is a front cut-away view of an alternate exemplary embodiment of a flowable product applicator.

FIG. 6 is a block diagram of an exemplary embodiment of a control system.

FIG. 7 is a perspective partially cut-away view of another alternate embodiment of a hand cleansing system.

### DETAILED DESCRIPTION OF THE INVENTION

Embodiments of sheet product dispenser systems are provided.

In this regard, users often use flowable products such as, for example, soaps, antibacterial substances, and lotions when cleansing their hands. Some sheet product dispensers dispense sheet products that have a flowable product impregnated on the sheet product prior to installing the sheet product in the dispenser. One disadvantage of this type of dispenser is that a sheet product cannot be dispensed that does not include the flowable product. Additionally, the type of flowable product cannot be changed without changing the sheet product.

Applying the flowable product to the sheet product while the sheet product is being dispensed, also allows a dispenser to dispense a number of types of flowable products on a sheet product that may be selected by a user. For example, a user may elect to receive sheet product having no flowable product. Alternatively, a user may elect to receive a sheet product having a flowable product. If the system includes more than one flowable liquid, a user may elect to receive a sheet product having either or both flowable products.

The term “sheet products” as used herein is inclusive of natural and/or synthetic cloth or paper sheets. Sheet products may include both woven and non-woven articles. There are a wide variety of nonwoven processes and they can be either wetlaid or drylaid. Some examples include hydroentangled (sometimes called spunlace), DRC (double re-creped), airlaid, spunbond, carded, paper towel, and meltblown sheet products. Further, sheet products may contain fibrous cellulosic materials that may be derived from natural sources, such as wood pulp fibers, as well as other fibrous material characterized by having hydroxyl groups attached to the polymer backbone. These include glass fibers and synthetic fibers modified with hydroxyl groups. Examples of sheet products include, but are not limited to, wipers, napkins, tissues, rolls, towels or other fibrous, film, polymer, or filamentary products.

In general sheet products are thin in comparison to their length and breadth and exhibit a relatively flat planar configuration and be flexible to permit folding, rolling, stacking, and the like. The sheet product may have perforations extending in lines across its width to separate individual sheets and facilitate separation or tearing of individual sheets from the roll at discrete intervals. Individual sheets may be sized as desired to accommodate the many uses of the sheet products. For example, perforation lines may be formed every 13 inches to define a universally sized sheet. Multiple perforation lines may be provided to allow the user to select the size of sheet depending on the particular need.

While reference is made herein to soap, antibacterial substance or lotion, it will be appreciated that the scope of the invention is not so limited, and extends to other flowable products, such as liquid soap, foam, gel, lotion, detergent, or any other flowable product capable of being dispensed from a dispenser, for example.

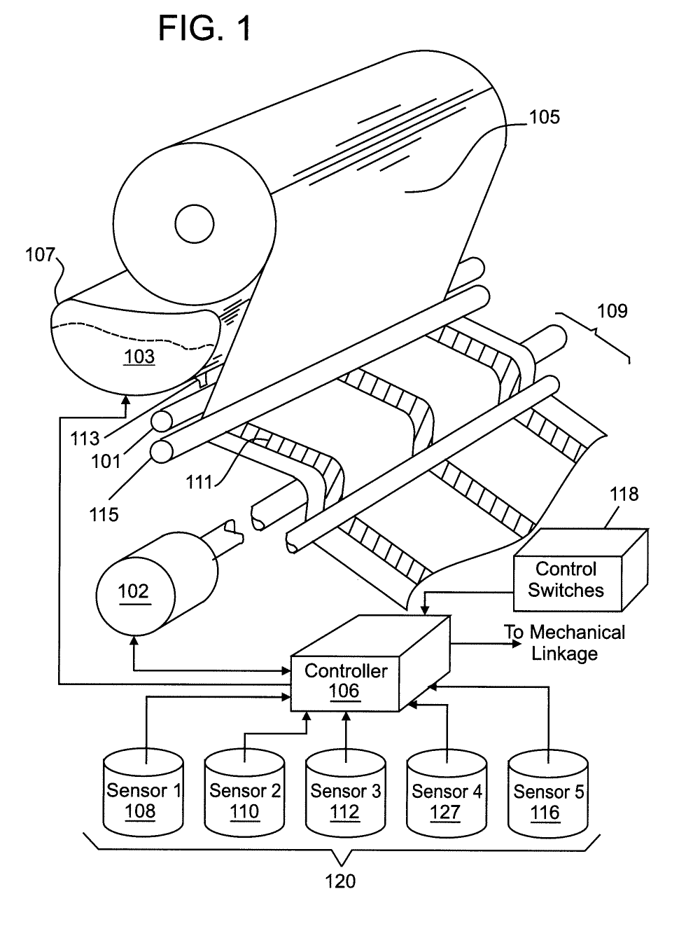

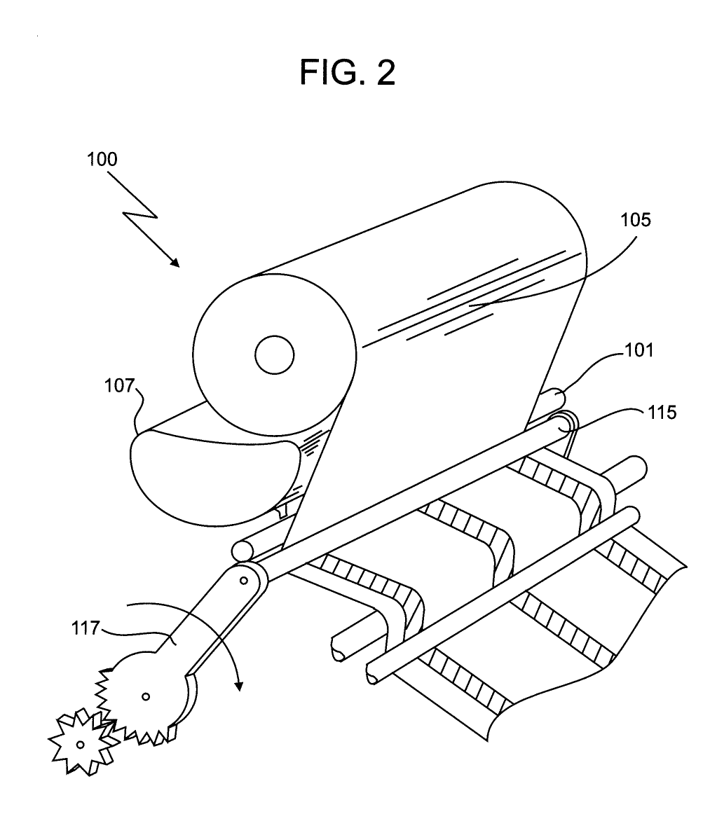

FIG. 1 illustrates a perspective partially cut-away view of an exemplary embodiment of a sheet product dispenser system 100 (FIG. 2). The sheet product dispenser system 100 includes a sheet product 105 a sheet product dispenser portion 109 having a motor 102, a flowable product dispenser 107 storing a first flowable product 103, a flowable product applicator 113, a first roller 101 and a second roller 115. The sheet product 105 has an applied flowable product portion 111. The sheet product dispenser system 100 also includes, a controller 106 communicatively linked to the flowable product dispenser 107, the motor 102, control switches 118, and sensors 120 (108, 110, 112, 127, and 116). The sensors 120 may be infrared sensors, laser sensors, capacitive sensors, or any other sensor that may determine the proximity of an object, such as but not limited to a hand for example. The controller 106 may include, for example, a processor or an electronic circuit operative to send and receive signals and control the sheet product dispenser system 100.

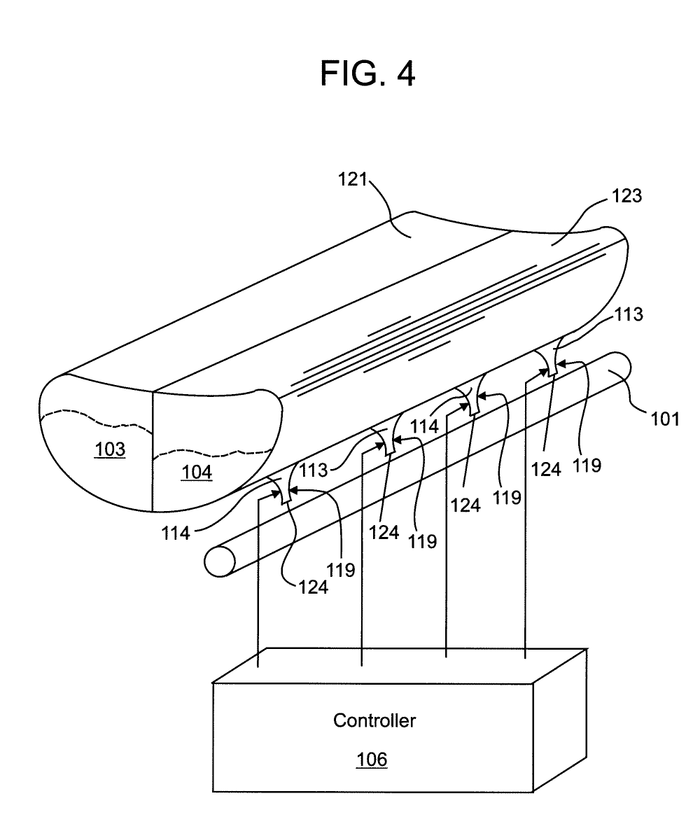

In operation the sheet product dispenser portion 109 may be mechanically operated by a user operating a mechanical linkage (not shown) or electro-mechanically operated via the motor 102. The first sensor 108 is associated with dispensing the sheet product 105. The second through fifth sensors 110, 112, 127, and 116 are associated with dispensing the first flowable product 103. If an object is placed proximate to one of the second through fifth sensors 110, 112, 127, and 116, a signal is sent to the controller 106 that controls a mechanical linkage 117 (shown in FIG. 2) and valves 119 (shown in FIG. 4). The controller 106 may also include switches that are operative to control a sheet length of the dispensed sheet product 105, and a delay in dispensing the sheet product 105 and the first flowable product 103. The controller 106 may also use switches to control the sheet product dispenser portion 109 and the flowable product dispenser 107.

If, for example, a user desires the sheet product 105 that includes a flowable product, the user first places an object proximate to the second sensor 110 that is associated with the flowable product dispenser 107. The controller 106 receives the signal. Once the user places an object proximate to the first sensor 108 the controller 106 sends signals to the sheet product dispenser portion 109. As the sheet product 105 is dispensed, the flowable product dispenser 107 disposes the first flowable product 103 onto the first roller 101 via the flowable product applicator 113. In a dispensing mode, the second roller 115 engages the sheet product 105 such that the sheet product 105 engages the first roller 101. The first roller 101 rotates, and the engagement of the first roller 101 and the sheet product 105 causes the first flowable product 103 to be transferred to the sheet product 105 resulting in the applied flowable product portion 111.

The illustrated embodiment includes three flowable product applicators 113 resulting in three applied flowable product portions 111. Other embodiments may include more or less flowable product applicators 113 resulting in corresponding numbers of applied flowable product portions 111. The control switches 118 may be used in combination with the sensors 120 or alone to operate the sheet product dispenser system 100 as described above.

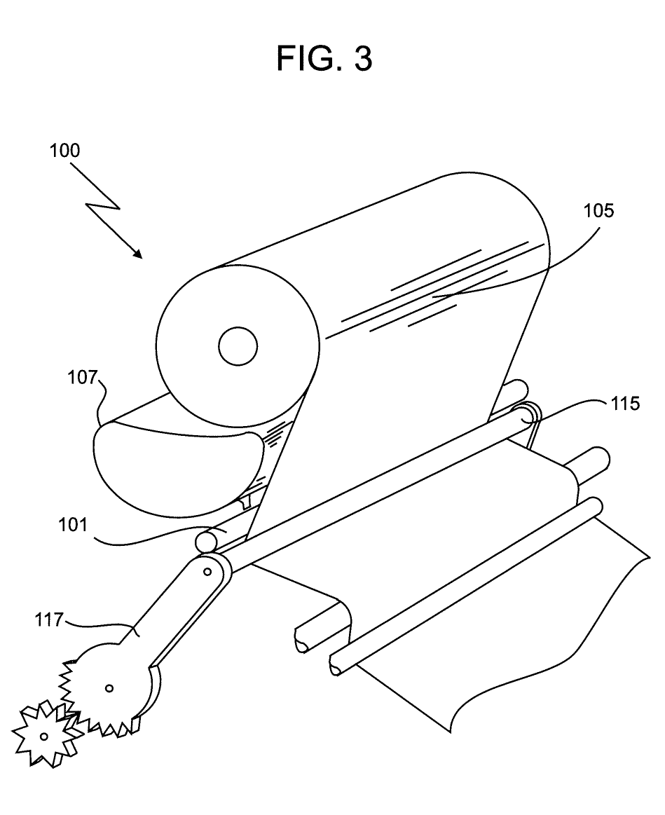

FIGS. 2 and 3 (with periodic reference to FIG. 1) illustrate an alternate embodiment of the sheet product dispenser system 100. FIGS. 2 and 3 include the mechanical linkage 117 linked to the second roller 115. In operation, the mechanical linkage 117 is operative to position the second roller 115 in a first position illustrated in FIG. 2. In the first position, the second roller 115 engages the sheet product 105 such that the sheet product 105 engages the first roller 101. The mechanical linkage 117 is further operative to position the second roller 115 in a second position illustrated in FIG. 3. In the second position, the second roller 115, engages the sheet product 105 such that the sheet product 105 disengages the first roller 101. When the sheet product 105 disengages the first roller 101, the first flowable product 103 is not transferred to the sheet product 105. Thus, the sheet product 105 not having an applied flowable product may be dispensed.

The mechanical linkage 117 may be mechanically actuated by a user, or may be electromechanically actuated when a signal from, for example, a switch or a sensor 120 is received by the controller 106. In this regard, if, for example, a user places an object proximate to the first sensor 108, the controller 106 receives a signal from the first sensor 108 and sends a signal to the mechanical linkage 117 to place the second roller 115 into the second position. The sheet product dispenser portion 109 may then dispense the sheet product 105 without the first flowable product 103. Alternatively, the third sensor 112, and the fourth sensor 127, may be associated with the mechanical linkage 117 and may be operative to control the mechanical linkage 117 via the controller 106.

FIG. 4 illustrates an alternate embodiment of flowable product dispensers. FIG. 4 includes a first flowable product dispenser 121 having a cavity that stores the first flowable product 103. FIG. 4 also includes a second flowable product dispenser 123 having a cavity that stores a second flowable product 104. The illustrated flowable product dispensers 121 and 123 also include the flowable product applicators 113 and second flowable product applicators 114. The first and second flowable product applicators 113 and 114 include openings 124 that engage valves 119. In operation, the valves 119 control the deposition of the first and second flowable products 103 and 104 onto the first roller 101.

The valves 119 may be mechanically controlled by a user, or electromechanically actuated when the valves 119 receive a signal from the controller 106. By opening and closing the valves 119 corresponding to the first and second flowable product applicators 113 and 114 one or both of the first and second flowable products 103 and 104 may be disposed onto the first roller 101. The controller 106 may control the valves 119 after receiving signals from the sensors 120 (FIG. 1) that are associated with the first and second flowable product applicators 113 and 114.

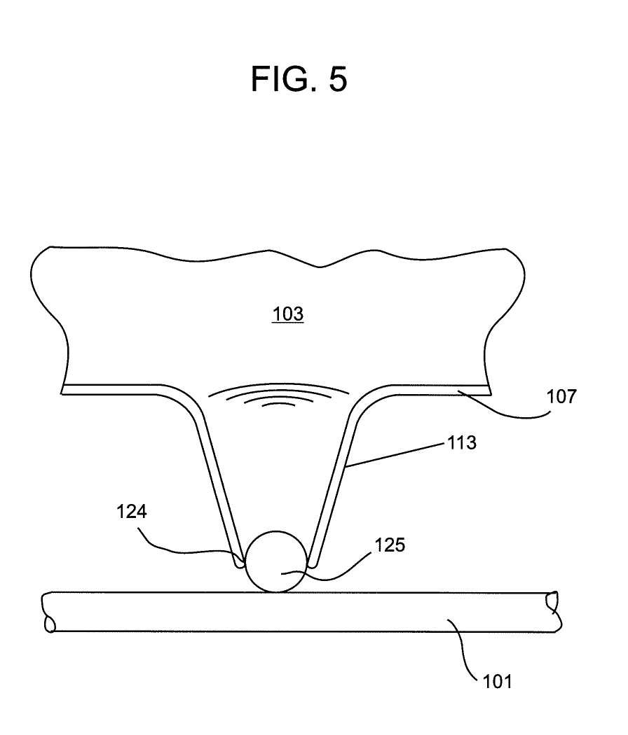

FIG. 5 illustrates an alternate embodiment of the flowable product applicator 113. The flowable product applicator 113 includes a ball member 125 that engages an opening 124 in the flowable product applicator 113. The flowable product applicator 113 engages the flowable product dispenser 107 that stores the first flowable product 103.

In operation during a dispensing mode, the ball member 125 contacts the first roller 101 and rotates as the first roller 101 rotates. The ball member 125 is operative to control the flow of the first flowable product 103 as it is disposed onto the first roller 101.

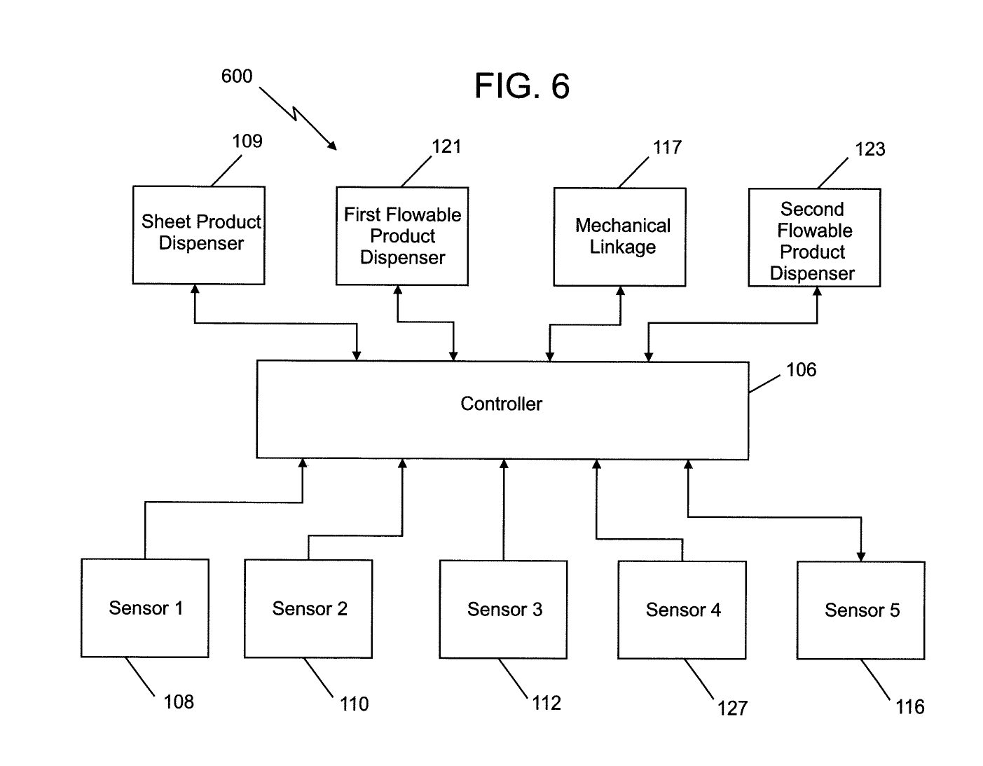

FIG. 6 (with periodic reference to FIGS. 1, 2, 3 and 4) illustrates a block diagram of an embodiment of a control system 600 for the sheet product dispenser system 100. FIG. 6 includes sensors 120; the first sensor 108 associated with the sheet product dispenser portion 109, the second sensor 110 associated with the first flowable product dispenser 121, the third and a fourth sensors 112 and 127 associated with the mechanical linkage 117, and the fifth sensor 116 associated with the second flowable product dispenser 123.

In operation the sensors 120 are operative to sense when an object, such as, for example, a hand is proximate to the sensors 120. Upon sensing a proximate object, the sensors 120 output a signal to the controller 106. For example, if a user desires the sheet product 105 without a flowable product, the user may place a hand proximate to the third sensor 112 that responsively sends a third signal to the controller 106 in signal communication with the mechanical linkage 117. The mechanical linkage 117 receives a command responsive to the third signal and responsively moves the second roller 115 into the second position (of FIG. 3) such that the sheet product 105 disengages from the first roller 101. The user may then place a hand proximate to the first sensor 108 that sends a first signal to the controller 106 in signal communication with the sheet product dispenser portion 109. The sheet product dispenser portion 109, via a command responsive to the first signal, then may dispense the sheet product 105 without the first flowable product 103. A fourth sensor 127 may be used to send a fourth signal to the controller 106 in signal communication with the mechanical linkage 117, which in an embodiment is operative to return the second roller 115 to the first position (of FIG. 2). The fourth sensor 127 may in some embodiments, not be included, and the mechanical linkage 117 may automatically return to the first position after the sheet product dispenser portion 109 has completed dispensing the sheet product 105.

The second sensor 110 is operative to send a second signal to the controller 106 that is operative to control the first flowable product dispenser 121. The valves 119 (of FIG. 4) may be actuated to open or close responsive to receiving a signal from the controller 106. The fifth sensor 116 sends a fifth signal to the second flowable product dispenser 123 via the controller 106 that may actuate the valves 119 (FIG. 4). Opening and closing the valves 119 may control the deposition of the first flowable product 103 and the second flowable product 104 onto the first roller 101. Thus, a user may select whether either or both the first and second flowable products 103 and 104 are transferred onto the dispensed sheet product 105.

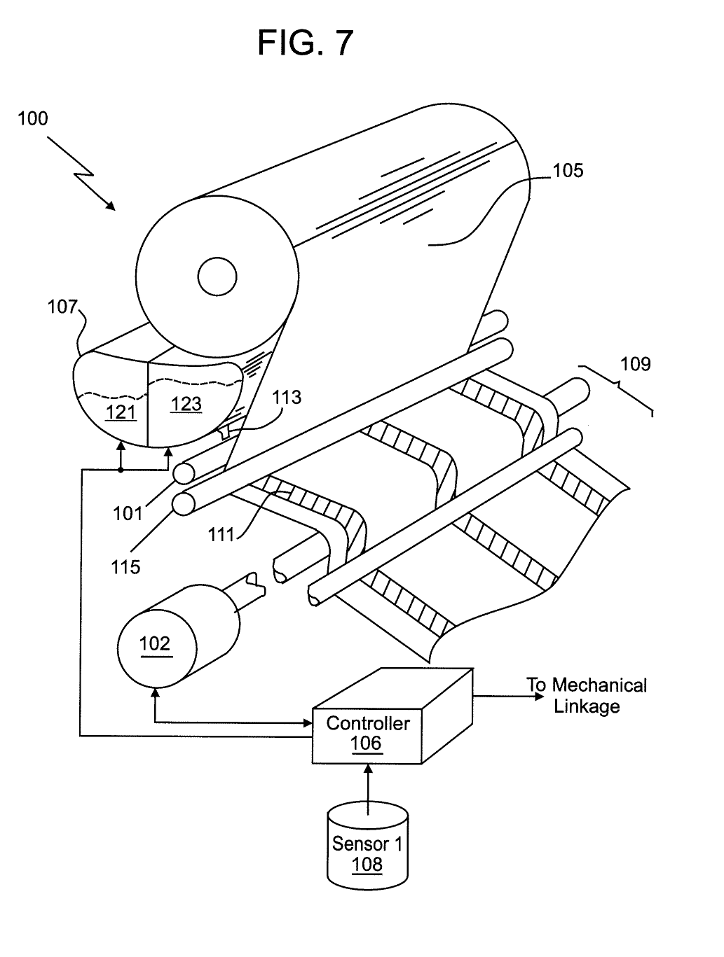

Another alternate embodiment of the sheet product dispenser system 100 is shown in FIG. 7. The embodiment of FIG. 7 includes the first sensor 108 communicatively linked to the controller 106. The controller 106 is communicatively linked to the motor 102 of the sheet product dispenser portion 109, and the first flowable product dispenser 121 and the second flowable product dispenser 123. The controller 106 may also be communicatively linked to the mechanical linkage 117 (FIG. 6). The controller 106 includes switches that are operative to control the operation of the sheet product dispenser system 100, including delays in the operation of the sheet product dispenser system 100 and the sheet length of the sheet product 105 dispensed by the sheet product dispenser portion 109.

In operation, the first sensor 108 sends a signal to the controller 106 when an object is proximate to the first sensor 108. The controller 106 controls the sheet product dispenser system 100 such that the first flowable product dispenser 121 and the second flowable product dispenser 123 dispense one or a combination of flowable products. The controller 106 also controls the sheet product dispenser portion 109 that may dispense the sheet product 105. The controller 106 may also control the mechanical linkage 117 (FIG. 6).

The exemplary operation of the sensors 120 described above is not limiting, and embodiments of the sheet product dispenser system 100 may include any combination of sensors 120, or push-button type control switches 118 that are productive of the aforementioned signals depending on a user's preference.

By engaging or disengaging the sheet product 105 from the first roller 101, the sheet product dispenser system 100 may dispense the sheet product 105 with or without the first flowable product 103. Embodiments of the sheet product dispenser system 100 that include two flowable product dispensers allow the dispenser to dispense two types of flowable products. Embodiments including the valves 119 allow either or both types of flowable products to be transferred onto the dispensed sheet product 105. A system of sensors, buttons, switches, or mechanical linkages or any combination thereof may be used to operate the embodiments described above.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A sheet product dispenser system comprising:
a sheet product dispenser portion operative to dispense a sheet product;
a first roller operative to transfer a flowable product from the first roller to the sheet product; and
a first flowable product dispenser having a cavity partially defined by a first flowable product container, operative to store the first flowable product; and
a first flowable product applicator engaging the first flowable product container and operative to apply the first flowable product to the first roller, the first flowable product applicator including:
an opening partially defined by the first flowable product applicator communicative in fluid communication with the cavity and the outer surface; and
a ball member engaging the opening operative to control dispensing of the first flowable product on the first roller

2. The system of claim 1, wherein the system further comprises a second roller operative to engage the sheet product such that the sheet product engages the first roller.

3. The system of claim 1, wherein the system further comprises the second roller linked to a mechanical linkage, wherein the mechanical linkage is operative to position the second roller in a first position such that the second roller engages the sheet product such that the sheet product engages the first roller.

4. The system of claim 3, wherein the mechanical linkage is further operative to position the second roller in a second position such that the second roller engages the sheet product such that the sheet product disengages the first roller.

5. The system of claim 1, wherein the first flowable product dispenser further comprises a valve operative to control the disposition of the first flowable product on the first roller.

6. The system of claim 1, wherein the first flowable product dispenser further comprises a plurality of flowable product applicators operative to dispose the first flowable product on the first roller.

7. The system of claim 1, wherein the first flowable product applicator further comprises a valve operative to control dispensing of the first flowable product on the first roller.

8. The system of claim 1, wherein the system further comprises a second flowable product dispenser operative to dispose a second flowable product on the first roller.

9. The system of claim 1, wherein the system further comprises a first sensor operative to send a first signal responsive to sensing an object proximate to the first sensor, wherein the sheet product dispenser portion is operative to dispense the sheet product responsive to receiving the first signal.

10. The system of claim 1, wherein the system further comprises a second sensor operative to send a second signal responsive to sensing an object proximate to the second sensor, wherein the first flowable product dispenser is operative to dispense the first flowable product responsive to receiving the second signal.

11. The system of claim 4, wherein the system further comprises a third sensor operative to send a third signal responsive to sensing an object proximate to the third sensor, wherein the mechanical linkage is further operative to position the second roller in the second position responsive to receiving the third signal.

12. The system of claim 3, wherein the system further comprises a fourth sensor operative to send a fourth signal responsive to sensing an object proximate to the fourth sensor, wherein the mechanical linkage is further operative to position the second roller in the first position responsive to receiving the fourth signal.

13. The system of claim 10, wherein the system further comprises a fifth sensor operative to send a fifth signal responsive to sensing an object proximate to the fifth sensor, wherein the second flowable product dispenser is operative to dispense the second flowable product responsive to receiving the fifth signal.

14. A sheet product dispenser system comprising:
a sheet product dispenser portion;
a first roller operative to apply a flowable product to a sheet product;
a first flowable product dispenser operative to dispose a first flowable product on the first roller; and
a second flowable product dispenser operative to dispose a second flowable product on the first roller.

15. The system of claim 14, wherein the system further comprises a second roller operative to engage the sheet product such that the sheet product engages the first roller.

16. The system of claim 14, wherein the system further comprises the second roller linked to a mechanical linkage, wherein the mechanical linkage is operative to position the second roller in a first position such that the second roller engages the sheet product such that the sheet product engages the first roller.

17. The system of claim 16, wherein the mechanical linkage is further operative to position the second roller in a second position such that the second roller engages the sheet product such that the sheet product disengages the first roller.

18. The system of claim 14, wherein the system further comprises:
a first sensor operative to send a first signal responsive to sensing an object proximate to the first sensor, wherein the sheet product dispenser portion is operative to dispense the sheet product responsive to receiving the first signal;
a second sensor operative to send a second signal responsive to sensing an object proximate to the second sensor, wherein the first flowable product dispenser is operative to dispense the first flowable product responsive to receiving the second signal; and
a third sensor operative to send a third signal responsive to sensing an object proximate to the third sensor, wherein the second flowable product dispenser is operative to dispense the second flowable product responsive to receiving the third signal.

19. A sheet product dispenser system comprising:
a sheet product dispenser portion;
a first roller operative to apply a flowable product to a sheet product;
a first flowable product dispenser operative to dispose a first flowable product on the first roller;
a second flowable product dispenser operative to dispose a second flowable product on the first roller; and
a controller operative to receive signals and control the sheet product dispenser system.

20. The system of claim 19, wherein the system further comprises:
a first sensor operative to send a signal responsive to sensing an object proximate to the first sensor to the controller,
wherein the controller is further operative to receive the first signal and responsively control the sheet product dispenser portion, the first roller, the first flowable product dispenser, and the second flowable product dispenser.
